(19) United States
(12) Patent Application Publication
(10) Pub. No.: US 2014/0211608 A1
(43) Pub. Date: Jul. 31, 2014

(54) Method for Healing ZigBee Network

(71) Applicant: Yung Weng Fan, Singapore (SG)

(72) Inventor: Yung Weng Fan, Singapore (SG)

(73) Assignee: AAC TECHNOLOGIES PTE. LTD., Singapo (SG)

(21) Appl. No.: 14/162,892

(22) Filed: Jan. 24, 2014

(30) Foreign Application Priority Data
Jan. 29, 2013 (CN) 201310033239.4

(51) Int. Cl. H04W 24/04; H04W 4/00

(52) U.S. Cl. CPC H04W 24/04; H04W 4/008
USPC 370/219

(57) ABSTRACT

Disclosed is a ZigBee network healing method after the coordinator of the ZigBee network falls out and recovers subsequently. The method uses a router to determine whether a parent device of the router is the coordinator; if the router's parent is the coordinator, the router further determines a link status from the parent device; if the router determines the link status is not abnormal, the router activates a network recovery process.

### FIELD OF THE INVENTION

The present invention relates to a method for healing a ZigBee network after its coordinator falls out and recovers subsequently.

### DESCRIPTION OF RELATED ART

ZigBee is a standard based wireless technology designed to address the needs of low cost, low power, and reliable wireless sensor and control networks. ZigBee is developed by the ZigBee Alliance. The technology is based on the IEEE 802.15.4 standard and is widely used in the wireless sensor networks in many markets including Home Automation, Smart Energy, Smart Grid, Healthcare, Building Management, Environmental Control, and Safety etc.

ZigBee uses mesh networking topology. There are mainly three types of ZigBee devices in a network. They are the coordinator, router, and the end device. Each network has only one coordinator which is the master of the network. Each network is identified with a unique identifier called PANID (Personal Area Network ID) which is setup by the coordinator when the network is formed. The routers and the coordinator of the network transmit Link Status at regular interval to maintain the network. The Link Status consists of the PANID.

ZigBee network has the ability to detect and avoid PANID conflict. Before forming the network, the ZigBee coordinator scans the channels for neighboring networks. If the PANID is being used, the coordinator will choose another PANID to avoid the conflict. It gets the PANID of the neighboring networks by checking the Link Status transmitted by their routers or the coordinators.

This creates a problem. After the network is formed, the coordinator performs the network management. There are times when the coordinator drops out of the network, for instance, power failure or hardware breakdown. During this time, the routers continue to transmit the Link Status. When the coordinator recovers, it resets and starts forming the network. It scans the channels for conflicting PANID. Since the routers are continuing sending out the Link Status, the coordinator assumes that the PANID has already been taken and chooses a new PANID to form the network. Thus, the coordinator forms a new network eventually while the routers and the end devices remain in the original network.

### BRIEF DESCRIPTION OF THE DRAWINGS

FIG. 1 is a block diagram of a router of a ZigBee network in accordance with a first exemplary embodiment of the present disclosure.

FIG. 2 is a flow chart of a method for healing the ZigBee network in accordance with the first exemplary embodiment of the present disclosure.

FIG. 3 is a flow chart of a network recovery process of a parent router for healing the ZigBee network in accordance with a second exemplary embodiment of the present disclosure.

FIG. 4 is a flow chart of a network recovery process of children routers for healing the ZigBee network in accordance with the second exemplary embodiment of the present disclosure.

FIG. 5 is a timing diagram illustrating the states of the children router in FIG. 4.

### DETAILED DESCRIPTION OF THE EXEMPLARY EMBODIMENTS

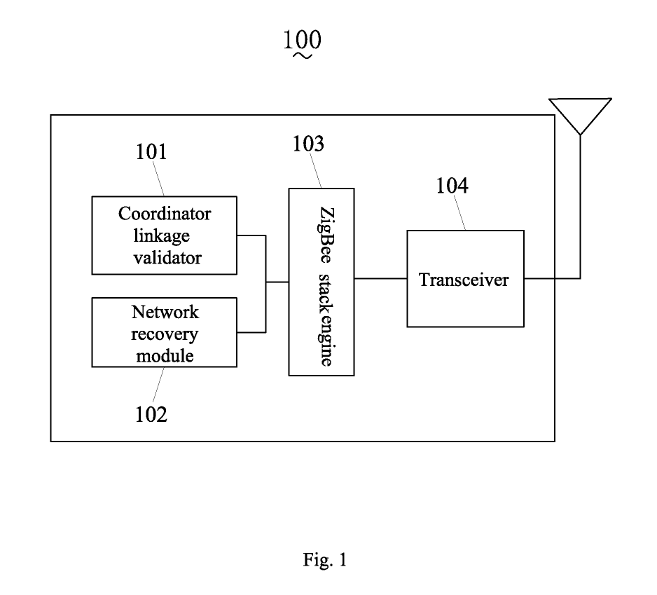

A ZigBee network comprises a coordinator, a router and an end device. The router, according to a first exemplary embodiment, is single model. Please referring to FIG. 1, the router 100 comprises a coordinator linkage validator 101, a network recovery module 102 communicated with the coordinator linkage validator 101, a ZigBee stack engine 103 respectively communicatively connected with the coordinator linkage validator 101 and the network recovery module 102, and a wireless transceiver 104 communicatively connected with the ZigBee stack engine 103.

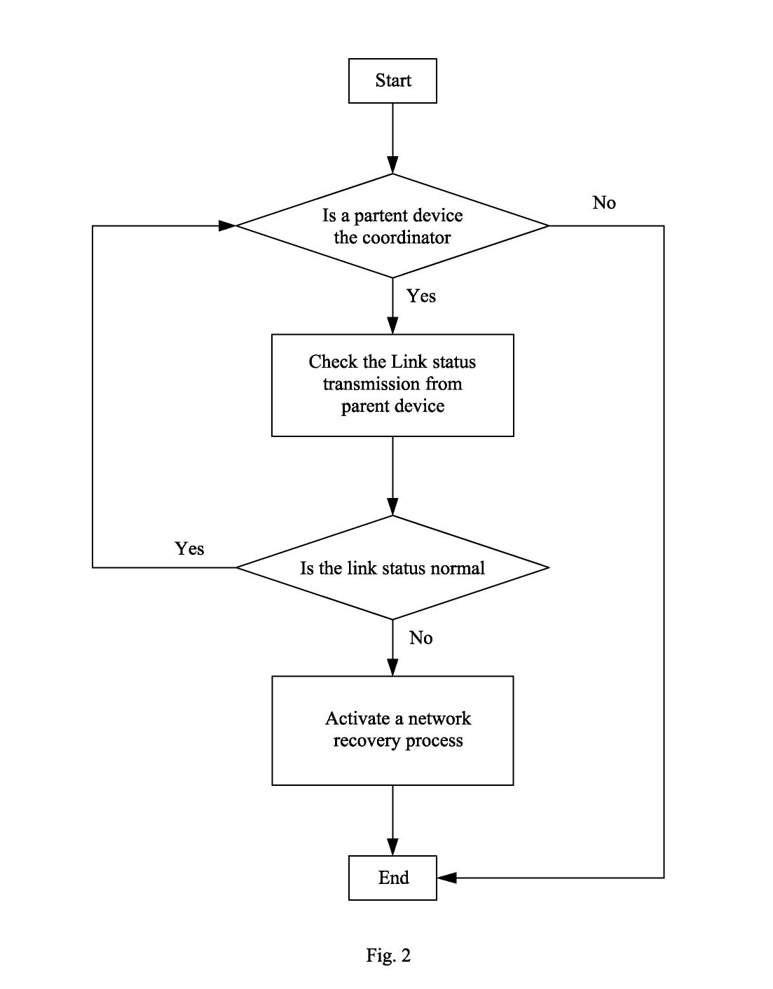

Referring to FIG. 2, a method for healing the ZigBee network comprises the steps of:

Step 11: the coordinator linkage validator 101 determines whether a parent device of the router 100 is the coordinator. If the parent device of the router 100 is not the coordinator, the coordinator linkage validator 101 stops working; if the router's parent is the coordinator, the coordinator linkage validator 101 further determines a link status from the parent device;

Step 12: if the coordinator linkage validator 101 determines the link status is normal, the Step 11 is repeated;

Step 13: if the coordinator linkage validator 101 determines the link status is not abnormal, the router 100 activates a network recovery process.

The network recovery process of step 13 comprises the steps of:

Step 21: The coordinator linkage validator 101 actives the network recovery module 102 of the router 100;

Step 22: The ZigBee stack Engine 103 shuts down the transceiver 104 for a predetermined time when it receives a network recovery message constructed by the network recovery module 102. The predetermined time can be various and according to different desires, eg.: five minutes or ten minutes. The predetermined timing can be adjusted based on the end device poll rate and the parent-child poll setting;

Step 23: the router 100 rests to find the coordinator for re-joining a new network and the transceiver 104 of router sends new link status. After the timeout period, the Network recovery module 102 will instruct the ZigBee stack engine 103 to reset. Thus, the router 100 resets.

A ZigBee network of a second embodiment of the present invention comprises a coordinator, a plurality of routers and an end device. The routers comprise a parent router and a plurality of children routers directly and indirectly communicated with the parent router. The parent router and the children routers in the second embodiment of the present invention are similar to the router in the first embodiment of the present invention. The parent router comprises a parent coordinator linkage validator, a parent network recovery module communicated with the parent coordinator linkage validator, a parent ZigBee stack engine respectively communicated connected with the parent coordinator linkage validator and the parent network recovery module, and a parent wireless transceiver communicatively connected with the parent ZigBee stack engine. Each of children routers comprises a children coordinator linkage validator, a children network recovery module communicated with the children coordinator linkage validator, a children ZigBee stack engine respectively communicatively connected with the children coordinator linkage validator and the children network recovery module, and a children wireless transceiver communicated connected with the children ZigBee stack engine.

A method for healing the ZigBee network according to the second embodiment of the present invention comprises the steps of:

Step 31: the coordinator linkage validator of the parent router determines whether a parent device of the parent router is the coordinator. if the parent device of the parent router is not the coordinator, the parent coordinator linkage validator stops working; if the parent device is the coordinator, the parent coordinator linkage validator further determines a link status from the parent device;

Step 32: if the parent coordinator linkage validator determines the link status is normal, the step 31 is repeated;

Step 33: if the parent coordinator linkage validator determines the link status is not abnormal, the routers activate a network recovery process.

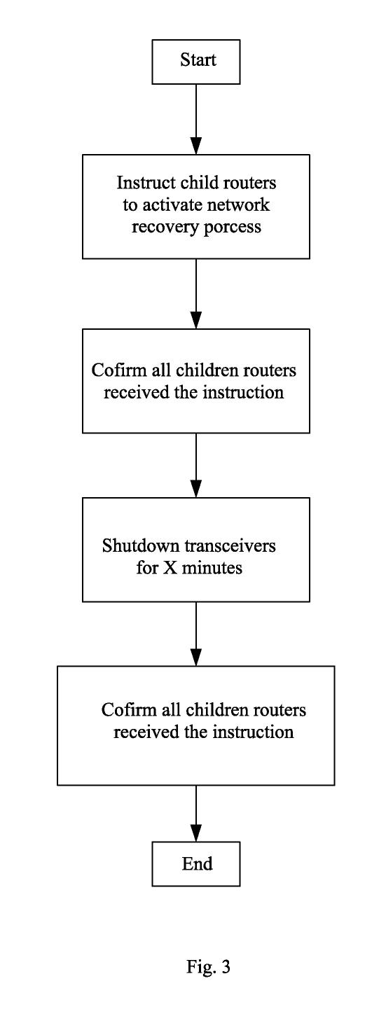

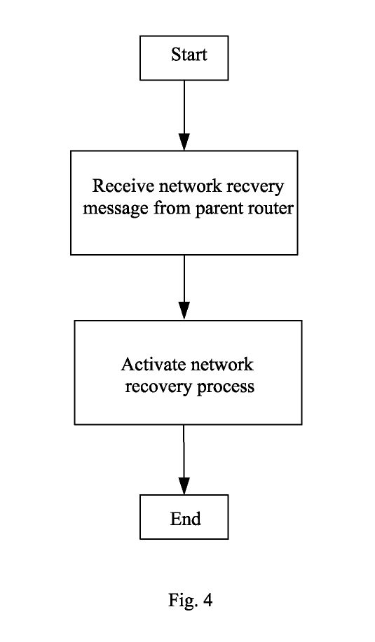

Referring to FIGS. 3 and 4, the network recovery process of Step 33 of the routers comprises the step of:

Step 41: the parent router instructs the children routers to activate network recovery process. The parent coordinator linkage validator activates the parent network recovery module. The parent network recovery module constructs activating messages and sends them to the parent ZigBee stack engine. The parent ZigBee stack engine schedules the activating messages and transmits them through the parent transceiver using broadcasting method. Each of children ZigBee stack engines receives the corresponding activating message via the children transceiver and transmits the corresponding activating message to the children network recovery module for activating the children network recovery modules;

Step 42: the parent router confirms all the children routers received the instruction. Each of children network recovery modules construct a confirmation message and send it to the children transceivers via the children ZigBee stack engine. The parent transceiver constructs a parent network recovery message when it receives the confirmation messages via the parent transceiver. In addition, each of children network recovery modules further constructs a children network recover message;

Step 43: the parent router shuts down for a predetermined time. The parent ZigBee stack engine shuts down the parent transceiver for a predetermined time when it receives the parent network recovery message constructed by the network recovery module. The predetermined time can be various and according to different desires, eg.: five minutes or ten minutes. The predetermined timing can be adjusted based on the end device poll rate and the parent-child poll setting;

Step 44: Each of children routers shuts down for a predetermined time. Each of children ZigBee stack engines shuts down the corresponding children transceiver for a predetermined time when it receives the children network recovery message constructed by the children network recovery modules. The predetermined time can be various and according to different desires, eg.: five minutes or ten minutes. The predetermined timing can be adjusted based on the end device poll rate and the parent-child poll setting;

Step 45: the parent router rests to find the coordinator for re-joining a new network and the parent transceiver sends new link status. After the timeout period, the parent Network Recovery module will instruct the parent ZigBee stack engine to reset. Thus, the parent router resets. In the reset process, the parent ZigBee stack engine turns on the transceiver and resumes the network search to find a new network;

Step 46: the children routers rest to find the parent router for re-joining a new network. After the timeout period, the children Network Recovery modules will instruct the children ZigBee stack engines to reset, respectively. Thus, the children routers reset. In the reset process, the children ZigBee stack engines will perform the power up sequence, turn on the children transceivers and search to find the new network;

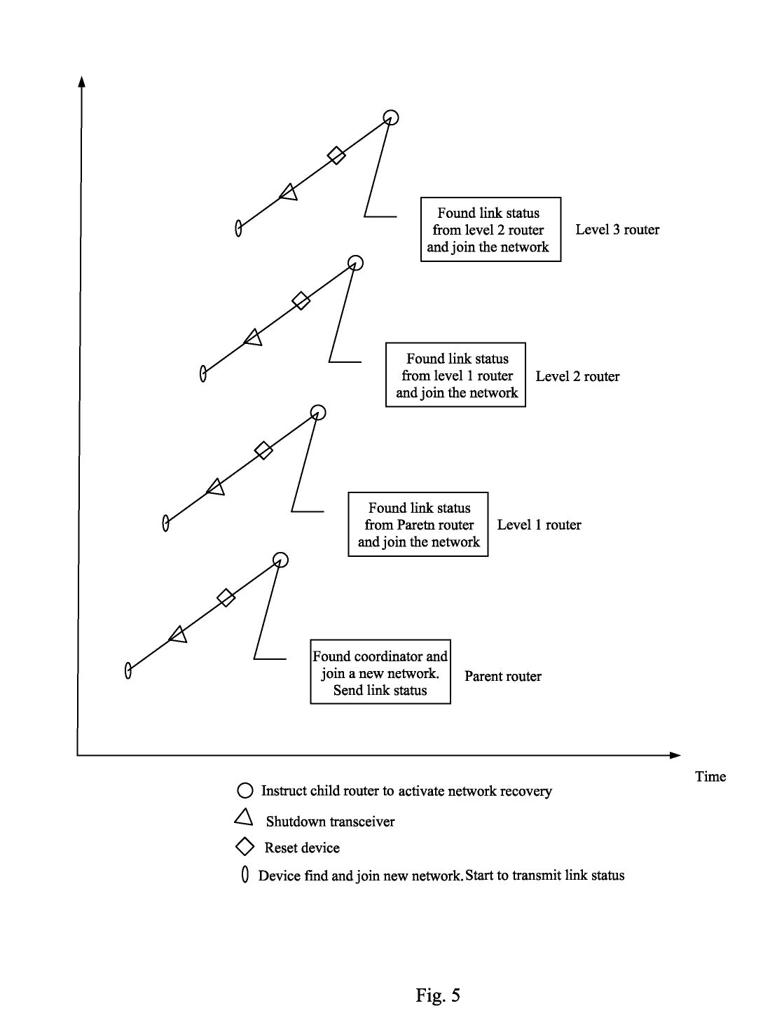

Referring to FIG. 5, optionally, the children routers are divided into a plurality of sub-levels routers such as three sub-levels routers (level 1 router, level 2 router and level 3 router). In step 46 of the second embodiment, the network recovery processes of the four sub-levels routers will perform sequence.

While the present invention has been described with reference to the specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A method for healing a ZigBee network comprising the steps of:
Step 10: providing the ZigBee network comprising a coordinator, a router and an end device, the router comprising a coordinator linkage validator, a network recovery module communicated with the coordinator, a ZigBee stack engine respectively communicatively connected with the coordinator linkage validator and the network recovery module, and a wireless transceiver communicatively connected with the ZigBee stack engine;
Step 11: determining whether a parent device of the router is the coordinator by the coordinator linkage validator, for stopping working if the parent device of the router is not the coordinator; or for determining a link status from the parent device if the parent device of the router is the coordinator;
Step 12: repeating step 11 if the coordinator linkage validator determines the link status is normal;
Step 13: activating a network recovery process if the coordinator linkage validator determines the link status is abnormal.

2. The method for healing the ZigBee network as described in claim 1, wherein Step 13 comprises the step of:
Step 21: activating the network recovery module of the router, by the coordinator linkage validator;
Step 22: shutting down the transceiver for a predetermined time when the ZigBee stack Engine receives a network recovery message constructed by the network recovery module;
Step 23: resting to find the coordinator for re-joining a new network by the router and sending new link status by the transceiver of the router.

3. A method for a healing ZigBee network comprising the steps of:
Step 30: providing the ZigBee network comprising a coordinator, a plurality of routers and an end device, the plurality of the routers comprising a parent router having a coordinator linkage validator, a network recovery module communicatively with the coordinator, a ZigBee stack engine respectively communicatively connected with the coordinator linkage validator and the network recovery module, and a wireless transceiver communicatively connected with the ZigBee stack engine;
Step 31: determining whether a parent device of the parent router is the coordinator by the coordinator linkage validator of the parent router, for stopping working if the parent device of the parent router is not the coordinator; or for determining a link status from the parent device if the parent device is the coordinator by the coordinator linkage validator;
Step 32: repeating step 31 if the coordinator linkage validator 101 determines the link status is normal;
Step 33: activating a network recovery process if the coordinator linkage validator 101 determines the link status is not abnormal by the routers.

4. The method for healing the ZigBee network as described in claim 1, wherein the Step 33 comprises the step of:
Step 41: instructing the children routers to activate network recovery process by the parent router;
Step 42: confirming all the children routers received the instruction by the parent router;
Step 43: shutting down for a predetermined time by the parent router;
Step 44: shutting down for a predetermined time by the children routers;
Step 45: resting to find the coordinator for re-joining a new network the parent router and sending new link status by the transceiver of the parent router;
Step 46: resting to find the parent router for re-joining a new network by the children routers.

5. The network healing method for ZigBee as described in claim 4, wherein the children router is divided into a plurality of sub-levels routers.
